(19) United States
(12) Patent Application Publication
(10) Pub. No.: US 2010/0071847 A1
(43) Pub. Date: Mar. 25, 2010

(54) Wafer bonding apparatus

(75) Inventors: Jae Bong Shin, Seoul (KR); Byung Joon Lee, Seongnam-si (KR); Seung Dae Seok, Seongnam-si (KR); Seung Woo Choi, Seoul (KR); Jung Hyeon Kim, Hwaseong-si (KR); Sang il Hong, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/461,933

(22) Filed: Aug. 28, 2009

(30) Foreign Application Priority Data
Sep. 24, 2008 (KR) 10-2008-0093594

(51) Int. Cl. B29C 65/00

(52) U.S. Cl. 156/285; 156/580; 156/382

(57) ABSTRACT

It is an aspect of the present invention to provide a wafer bonding apparatus having a pressing apparatus configured to press wafers fixed in a fixing apparatus, wherein the fixing apparatus is configured to allow the pressing apparatus to press the wafers without interference. The wafer bonding apparatus may include an upper wafer and a lower wafer, a support member configured to support the upper wafer and the lower wafer, a push member on the upper wafer, and a fixing apparatus configured to fix the push member to the support member, wherein the push member includes a fixing part extending outward from a periphery of the upper wafer, and the fixing apparatus is coupled to the fixing part. It is also an aspect of the present invention to provide a method for bonding wafers.

### CROSS-REFERENCE TO RELATED APPLICATION(S)

This application claims priority under 35 U.S.C. § 119 to Korean Patent Application No. 10-2008-0093594 filed on Sep. 24, 2008, in the Korean Intellectual Property Office (KIPO), the entire contents of which are herein incorporated by reference.

### BACKGROUND

1. Field

The following description relates to a wafer bonding apparatus and a method of bonding wafers. More particularly, the following description relates to a wafer bonding apparatus that may be capable of maintaining an alignment state of a wafer by fixing the wafer.

2. Description of the Related Art

A wafer bonding process may include the processes of pre-bonding wafer cleaning, sample loading, wafer bonding, and substrate removal. A wafer bonding apparatus may be used in the wafer bonding process. The wafer bonding apparatus may be used to bond a couple of wafers to each other using an adhesive interposed between the couple of wafers. The wafer bonding apparatus may be provided with a vacuum chamber and an aligner. The wafers may be aligned in the aligner, loaded in the vacuum chamber, and thereafter bonded to each other in the vacuum chamber.

Wafers being transferred from an aligner to the vacuum chamber may become misaligned. Accordingly, a fixing apparatus may be installed in the wafer bonding apparatus so as to maintain the alignment state of the wafers. The fixing apparatus may include a clamp to press and fix the wafers. In addition, the wafer bonding apparatus may be provided with a driving apparatus to release the clamp from the wafers.

The wafer bonding apparatus may be provided with a couple of pressing apparatuses for pressing the wafers. When the pressing apparatus is in the vacuum chamber, the pressing apparatus may press the wafers so that the wafers may be bonded to each other. In conventional wafer bonding apparatuses, the pressing apparatus may interfere with the fixing apparatus. Accordingly, the pressing apparatus may press the wafers after the fixing apparatus has been released from the wafers.

### SUMMARY

It is an aspect of the present invention to provide a wafer bonding apparatus having a pressing apparatus configured to press wafers fixed in a fixing apparatus, wherein the fixing apparatus is configured to allow the pressing apparatus to press the wafers without interference. It is also an aspect of the present invention to provide a method of bonding wafers.

Additional aspects and/or advantages of the invention will be set forth in part in the description which follows and, in part, will be apparent from the description, or may be learned by practice of the invention.

In accordance with an example embodiment of the present invention, a wafer bonding apparatus may include an upper wafer and a lower wafer, a support member configured to support the upper wafer and the lower wafer, a push member on the upper wafer, and a fixing apparatus configured to fix the push member to the support member, wherein the push member includes a fixing part extending outward from a periphery of the upper wafer, and the fixing apparatus is coupled to the fixing part.

In accordance with an example embodiment of the present invention, a wafer bonding apparatus may include an upper wafer and a lower wafer, a support member configured to support the upper wafer and the lower wafer, and a push member configured to apply a load to the upper wafer and the lower wafer, wherein the push member is on an outer side of an edge of the upper wafer and the lower wafer and is on the support member.

In accordance with an example embodiment of the present invention, a wafer bonding apparatus may include an upper wafer and a lower wafer, a push member configured to elastically support the upper wafer and the lower wafer, a spacer between the upper wafer and the lower wafer, and a driving apparatus for moving the spacer, wherein spacer is configured to move the push member.

In accordance with an example embodiment of the present invention, a method of bonding an upper wafer and a lower wafer may include aligning the lower wafer and the upper wafer on a support member, placing the support member with the aligned lower and upper wafers into a vacuum chamber, creating a vacuum in the vacuum chamber, withdrawing at least one spacer from between the lower and the upper wafer so that the upper wafer and the lower wafer contact one another, and operating vertical moving apparatus to press the upper wafer against the lower wafer.

In accordance with an example embodiment of the present invention, a wafer bonding apparatus may include an upper wafer and a lower wafer. The bonding apparatus may include a support member for supporting the upper wafer and the lower wafer, a push member supported by the upper wafer to apply a load, and a fixing apparatus for fixing the push member to the support member, wherein the push member includes a fixing part which extends outward from a periphery of the upper wafer, and the fixing apparatus is coupled to the fixing part.

According to an aspect of the present invention, the push member may be provided with a transfer part which may make contact with the upper wafer.

According to an aspect of the present invention, the wafer bonding apparatus may further include a pressing member for pressing the upper and lower wafers against each other, wherein the pressing member presses the transfer part.

According to an aspect of the present invention, the push member may be elastically supported by the support member.

According to an aspect of the present invention, the push member may include an elastic member.

According to an aspect of the present invention, the wafer bonding apparatus may further include a plurality of alignment pins which may be supported by the push member and the support member, wherein the alignment pins may be installed along a periphery of the upper wafer and the lower wafer to restrict a movement of the upper wafer and the lower wafer.

According to an aspect of the present invention, a notch part may be formed at an edge of the upper wafer and the lower wafer so as to accommodate a portion of the alignment pin therein.

According to an aspect of the present invention, the push member may be provided with a first alignment pin groove, the support member may be provided with a second alignment pin groove, and the alignment pin may extend by passing through the first alignment pin groove and inserted into the second alignment pin groove.

According to an aspect of the present invention, a plurality of alignment pin grooves may be provided corresponding to the alignment pins, and at least one of the alignment pin grooves may be provided in a form of an elongation groove.

According to an aspect of the present invention, the wafer bonding apparatus may further include a spacer assembly for maintaining an interval between an upper wafer and a lower wafer, wherein the spacer assembly may be installed at one of the support member and the push member so as to support one of the upper wafer and the lower wafer.

According to an aspect of the present invention, the spacer assembly may include a spacer having elasticity, and the spacer may bias the upper wafer dose to the push member or may bias the lower wafer dose to the support member.

According to an aspect of the present invention, the spacer may include a leaf spring.

According to an aspect of the present invention, the wafer bonding apparatus may further include a vacuum chamber, in which the upper wafer and the lower wafer may be loaded so as to be bonded to each other, and an aligner which may be installed at an outside of the vacuum chamber to align the upper wafer with the lower wafer.

It is another aspect of the present invention to provide a wafer bonding apparatus including an upper wafer and a lower wafer, a support member for supporting the upper wafer and the lower wafer, and a push member which may apply a load to the upper wafer and the lower wafer, wherein the push member may be disposed at an outer side of an edge of the upper wafer and the lower wafer and mounted on the support member.

It is another aspect of the present invention to provide a wafer bonding apparatus It is another aspect of the present invention to provide a wafer bonding apparatus including an upper wafer and a lower wafer, a support member for supporting the upper wafer and the lower wafer, and a push member which may apply a load to the upper wafer and the lower wafer, wherein the push member may be disposed at an outer side of an edge of the upper wafer and the lower wafer and mounted on the support member.

According to an aspect of the present invention, the wafer bonding apparatus may further include a pressing member for pressing the upper wafer and the lower wafer against each other, and the pressing member may be configured to press the upper wafer.

According to an aspect of the present invention, the push member may be elastically supported by the support member and may adhere to the upper wafer and the lower wafer.

It is another aspect of the present invention to provide a wafer bonding apparatus including an upper wafer and a lower wafer, a push member for elastically supporting the upper wafer and the lower wafer, a spacer disposed between the upper wafer and the lower wafer, and a driving apparatus for moving the spacer, wherein the push member is movable while interacting with the spacer.

According to an aspect of the present invention, the push member may be provided with a first body part having an interlocking groove, the spacer may be provided with a second body part having an interlocking projection, and the interlocking projection may be inserted into the interlocking groove.

According to an aspect of the present invention, the interlocking groove may be provided in a form of an elongation groove larger than the interlocking projection.

As described above, the wafer bonding apparatus according the embodiment of the present invention may prevent wafers from being misaligned when the pressing member presses the wafers.

In addition, wafers may be prevented from being misaligned when the spacer is separated from between the wafers.

Further, the additional process for releasing the fixing apparatus may be unnecessary when the pressing member process the wafers, so that the process time may be shortened.

In addition, when the spacer is separated from between the wafers, the spacer may interact with the push member. Accordingly, an additional apparatus for driving the push member may be unnecessary, so that the manufacturing cost may be reduced.

### BRIEF DESCRIPTION OF THE DRAWINGS

These and/or other aspects of the invention will become apparent and more readily appreciated from the following description of the example embodiments, taken in conjunction with the accompanying drawings of which:

FIG. 1 is a view representing a wafer bonding apparatus according to an example embodiment of the present invention;

FIG. 2 is an exploded perspective view representing a support member according to an example embodiment of the present invention;

FIGS. 3 and 4 are views showing a manual alignment process according to an example embodiment of the present invention;

FIG. 5 is a view showing an automatic alignment process according to an example embodiment of the present invention;

FIG. 6 is a view showing a space being separated from between wafers according to an example embodiment of the present invention;

FIG. 7 is a view showing a pressing member pressing a push member according to an example embodiment of the present invention;

FIG. 8 is a view representing a wafer bonding apparatus according to an example embodiment of the present invention;

FIG. 9 is an enlarged view of ‘A’ shown in FIG. 8;

FIG. 10 is a view representing a support member according to an example embodiment of the present invention as illustrated in FIG. 8;

FIG. 11 is a view showing a spacer being separated from between wafers according to an example embodiment of the present invention as illustrated in FIG. 8; and

FIG. 12 is a view showing a spacer that interacts with a push member according to an example embodiment of the present invention as illustrated in FIG. 8.

### DETAILED DESCRIPTION

Example embodiments of the present invention will now be described more fully with reference to the accompanying drawings, in which example embodiments are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments.

Reference will now be made in detail to the example embodiments of the present invention, examples of which are illustrated in the accompanying drawings, wherein like reference numerals refer to the like elements throughout. The example embodiments of the present invention are described below to explain the general concepts of the present invention.

Hereinafter, a wafer bonding apparatus, according to a first example embodiment of the present invention, will be described in detail with reference to accompanying drawings.

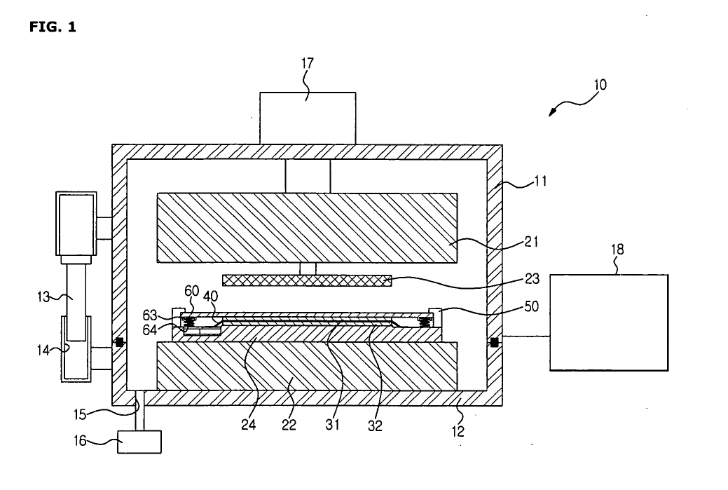

FIG. 1 is a view representing a wafer bonding apparatus according to a first example embodiment of the present invention.

As shown in FIG. 1, a wafer bonding apparatus according to a first example embodiment of the present invention is provided with a vacuum chamber 10 including an upper chamber 11 and a lower chamber 12. The upper chamber 11 may be coupled to the lower chamber 12 through a piston 13 and a cylinder 14. If the upper chamber 11 is separated from the lower chamber 12, the vacuum chamber 10 is open. If the upper chamber 11 is coupled to the lower chamber 12, the vacuum chamber 10 is dosed. If the vacuum chamber 10 is closed, a vacuum pump 16 connected to a drain pipe 15 may operate to create a vacuum in the vacuum chamber 10.

An upper stage 21 and a lower stage 22 may be disposed at an upper side and a lower side of the vacuum chamber 10, respectively, in opposition to each other. A pressing member 23 may be installed at the upper stage 21 and a support member 24 may be installed on the lower stage 22. The upper stage 21 and the lower stage 22 may be provided with a heater capable of heating the pressing member 23 and the support member 24, respectively. In addition, a vertical moving apparatus 17 may be coupled to the upper chamber 11 to move the upper stage 21 in a longitudinal direction, for example, a vertical direction. As the upper stage 21 moves upward or downward, the pressing member 23 may move upward or downward.

The support member 24 may be movable and may be moved from outside the vacuum chamber 10 to inside the vacuum chamber 10. For example, the support member 24 may be positioned at an aligner 18 and then moved inside the vacuum chamber 10. The support member 24 may also be configured to support an upper wafer 31 and a lower wafer 32.

According to the first example embodiment of the present invention, the support member 24 may be positioned at an aligner 18 and the upper wafer 31 and the lower wafer 32 may be aligned with each other. The support member 24 with the upper wafer 31 and the lower wafer 32 may be moved inside the vacuum chamber 10. While the support member 24 is in the vacuum chamber 10, the upper wafer 31 may be bonded to the lower wafer 32. The upper wafer 31 and the lower wafer 32 may become misaligned while the support member 24 is moved from the aligner 18 to the vacuum chamber 10, so an apparatus for maintaining the alignment state of the upper wafer 31 and the lower wafer 32 may be required.

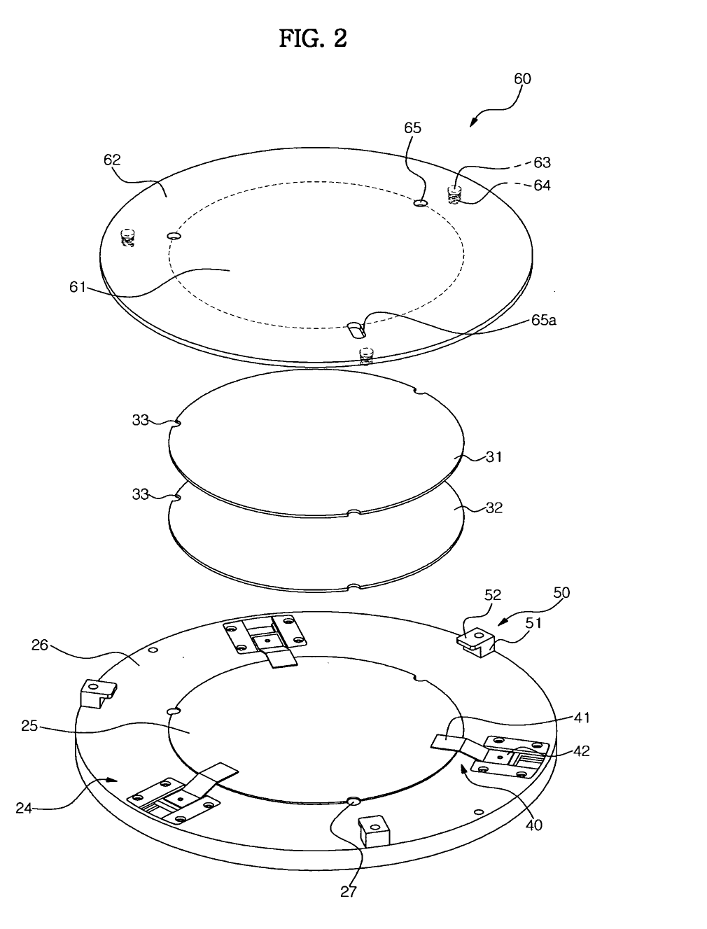

FIG. 2 is an exploded perspective view representing the support member according to the first example embodiment of the present invention.

As shown in FIGS. 1 and 2, the support member 24 according to the first example embodiment of the present invention may include, at the center thereof, a support part 25, at which the wafers 31 and 32 may be supported. In addition, an installation part 26 for installing spacers 40 and fixing apparatuses 50 may be formed around the center of the support member 24. The lower wafer 32 may be placed on the support part 25 and the upper wafer 31 and a push member 60 may be placed on the lower wafer 32. For example, the upper wafer 31 and the push member 60 may be sequentially placed on the lower wafer 32. The spacers 40 and fixing apparatuses 50 may be installed on the installation part 26 and may be spaced apart from each other while maintaining regular angular intervals of 120°. The spacer 40 may maintain a gap between the upper wafer 31 and the lower wafer 32, and the fixing apparatus 50 may maintain the alignment of the upper wafer 31 and the lower wafer 32. The spacer 40 may be inserted between the upper wafer 31 and the lower wafer 32, and the fixing apparatus 50 may fix the push member 60. As shown in FIG. 1, the lower wafer 32 may be placed on the support part 25. The spacer 40 may be disposed between the lower wafer 32 and the upper wafer 31 such that the upper wafer 31 is placed on the spacer 40. The push member 60 may be placed on the upper wafer 31.

The push member 60 may be larger than the upper wafer 31. The push member 60 may include a transfer part 61 corresponding to the upper wafer 31 and a fixing part 62 extending from the transfer part 61. The transfer part 61 may make contact with the upper wafer 31, and the fixing part 62 may extend outward from an edge of the upper wafer 31 without making contact with the upper wafer 31.

The push member 60 may be disposed on the upper wafer 31 while being spaced apart from the support member 24 at a predetermined or preset interval. Accordingly, the load of the push member 60 may be fully applied to the upper wafer 31. In this case, the upper wafer 31 may be placed on the spacer 40 so the load of the push member 60 is applied to the spacer 40 as well. Because the spacer 40 may be disposed between the upper wafer 31 and the lower wafer 32, deformation or damage, for example, a scratch, may occur in the upper wafer 31 or the lower wafer 32 when the spacer 40 is separated from the wafers 31 and 32. In this respect, the push member 60 may be elastically supported by the support member 24 such that the support member 24 may support a part of the load of the push member 60. For example, a first elastic member 64 may be installed on a first boss 63 that may be formed at the bottom of the fixing part 62 so that an upper side of the first elastic member 64 is supported by the fixing part 62, and a lower side of the first elastic member 64 is supported by the support member 24. The first elastic member 64 may include a compression coil spring. As a result, the load of the push member 60 may be partially applied to the upper wafer 31 and the support member 24, so that the load of the push member 60 is prevented from being concentrated on the spacer 40.

The push member 60 may serve to maintain the alignment state of the upper wafer 31 and the lower wafer 32 by transferring the load of the push member 60 to the upper wafer 31. However, because the push member 60 may be simply supported by the upper wafer 31 and the support member 24, the upper wafer 31 and the lower wafer 32 may be misaligned while the support member 24 is being transferred. Accordingly, the fixing apparatus 50 may be necessary to fix the push member 60 to the support member 24. The fixing apparatus 50 may include a clamp with a first body part 51 and a gripper part 52 extending from the body part 51. The first body part 51 may be rotatably mounted on the support member 24 and the support member 24 may be provided with a driving apparatus (not shown) for rotating the first body part 51. The gripper part 52 may fix the push member 60 by pressing the push member 60 downward. As the first body part 51 rotates, the gripper part 52 may make contact with the push member 60 or may be separated from the push member 60. The gripper part 52 may make contact with the fixing part 62 of the push member 60. If the gripper part 52 makes contact with the transfer part 61 of the push member 60, the gripper part 52 may interfere with the pressing member 23. The details thereof will be explained later.

As shown in FIG. 1, the alignment between the upper wafer 31 and the lower wafer 32 may be completed when the support member 24 is located in the aligner 18. The support member 24 may be loaded in the vacuum chamber 10 to bond upper wafer 31 to the lower wafer 32. The alignment operation between the upper wafer 31 and the lower wafer 32 will be explained, and then the bonding operation for the upper wafer 31 and the lower wafer 32 will be explained. A manual alignment process or an automatic alignment process may be performed for the upper wafer 31 and the lower wafer in the aligner 18. Hereinafter, the alignment process will be described in detail.

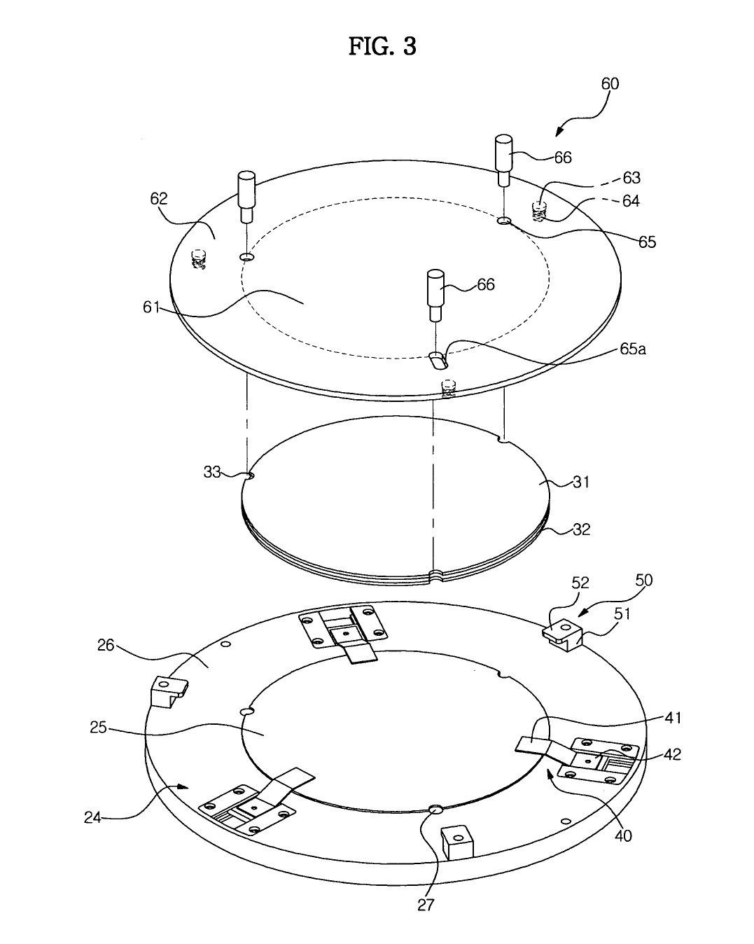

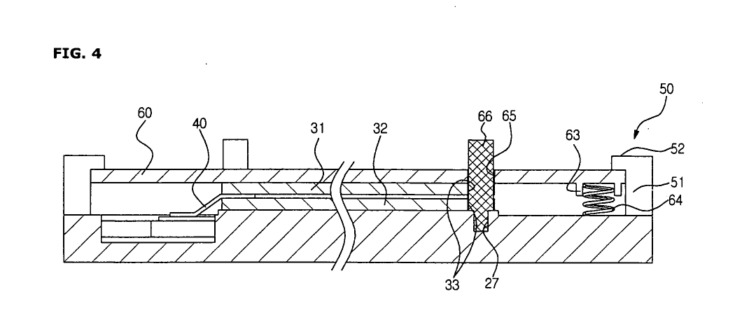

FIGS. 3 and 4 are views showing a manual alignment process according to the first example embodiment of the present invention.

As shown in FIGS. 1 to 4, the upper wafer 31 and the lower wafer 32 may have a circular shape. A notch part 33 having a predetermined or preset depth may be formed at a periphery of the upper wafer 31 and the lower wafer 32.

A plurality of first alignment pin grooves 65 may be formed on the push member 60. The first alignment pin grooves 65 may be formed on a boundary between the transfer part 61 and the fixing part 62. In addition, a plurality of second alignment pin grooves 27 may be formed at the support member 24 corresponding to the first alignment pin grooves 65. At least one of the first alignment grooves 65 formed on the push member 60 may be provided in the form of an elongation groove 65a.

An example of a manual alignment process will be described below. First, the lower wafer 32 may be placed on the support part 25 and the upper wafer 31 may be placed on the lower wafer 32. The spacer 40 may be inserted between the upper wafer 31 and the lower wafer 32. As shown in FIG. 3, the notch part 33 of the upper wafer 31 may match with the notch part 33 of the lower wafer 32. The notch parts 33 may match with one of the second alignment pin grooves 27 of the support member 24. The push member 60 may be placed on the upper wafer 31. The first alignment pin groove 65, the notch parts 33, and the second alignment pin groove 27 may be aligned with each other. As shown in FIG. 4, two alignment pins 66 may be inserted into the first alignment pin groove 65 and the second alignment pin groove 27. The notch part 33 may receive a portion of the alignment pin 66. The last alignment pin 66 may be inserted into the second alignment pin groove 27 by passing through the first alignment pin groove 65a having the elongation shape. As described above, the movement of the upper wafer 31 and the lower wafer 32 may be restricted by the plural alignment pins 66, so that the upper wafer 31 and the lower wafer 32 may be aligned to each other.

The fixing apparatus 50 may fix the push member 60 to the support member 24 in a state such that the upper wafer 31 is aligned with the lower wafer 32. The fixing apparatus 50 may maintain the alignment state of the upper wafer 31 and the lower wafer 32.

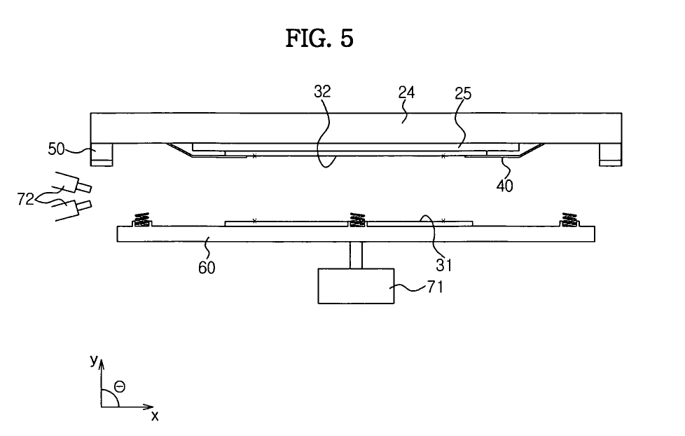

FIG. 5 is a view showing an example of an automatic alignment process according to the first example embodiment of the present invention.

As shown in FIGS. 1 and 5, the support member 24 may be disposed at an upper side and the push member 60 may be disposed at a lower side in the aligner 18 so that the automatic alignment process may be performed. The position of the support member 24 and the push member 60 shown in FIG. 1 may be different from the position of that of the support member 24 and the push member 60 shown in FIG. 5 because the spacer 40 may be provided on the support member 24.

The lower wafer 32 may be mounted on the support member 24. Because the spacer 40 may be coupled to the support member 24, the spacer 40 may support the lower wafer 32. The spacer 40 may be provided in the form of a leaf spring to fix the lower wafer 32 to the support member 24. Accordingly, the lower wafer 32 may be mounted on the support member 24 without being dropped from the support member 24. On the contrary, if the spacer 40 is provided on the push member 60, the automatic alignment process may be performed in a state that the support member 24 is disposed at a lower side and the push member 60 is disposed at an upper side in the aligner 18.

The upper wafer 31 may be mounted on the push member 60. A moving apparatus 71 may be installed at a lower side of the push member 60. The moving apparatus 71 may linearly move the push member 60 in an X-direction and a Y-direction, or rotate the push member 60 by an angle of θ. In addition, a position detection camera 72 may be installed to photograph alignment marks formed on the upper wafer 31 and the lower wafer 32. The position detection camera 72 may generate signals corresponding to a position of the upper wafer 31 and the lower wafer 32 and may provide a signal to a control apparatus (not shown). The control apparatus may analyze the signal, thereby driving the moving apparatus 71 such that the push member 60 moves in the X-direction or Y-direction, or rotates at an angle of θ. As a result, the upper wafer 31 may be automatically aligned with the lower wafer 32.

If the upper wafer 31 is aligned with the lower wafer 32, the fixing apparatus 50 may fix the push member 60 to the support member 24. The fixing apparatus 50 may maintain the alignment state of the upper wafer 31 and the lower wafer 32.

As shown in FIG. 1, after the alignment for the upper wafer 31 and the lower wafer 32 is performed through the manual alignment scheme or the automatic alignment scheme, the support member 24 may be transferred from the aligner 18 to the vacuum chamber 10. The support member 24 may be loaded into the vacuum chamber 10 and then mounted on the lower stage 22.

Hereinafter, the operation of the upper wafer 31 being bonded to the lower wafer 32 will be described in detail.

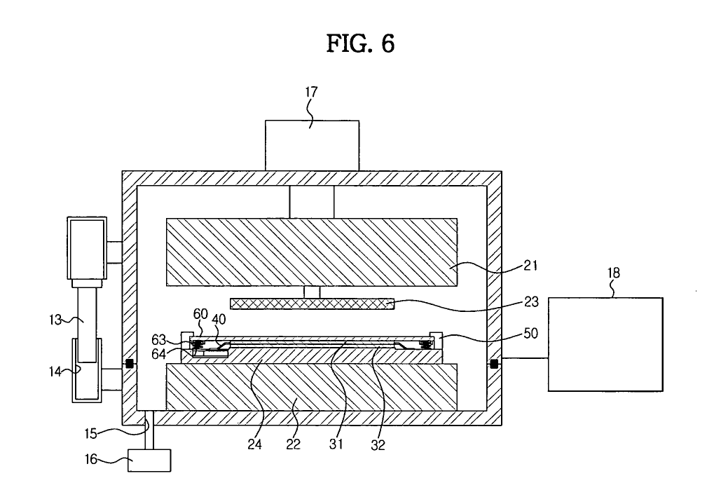

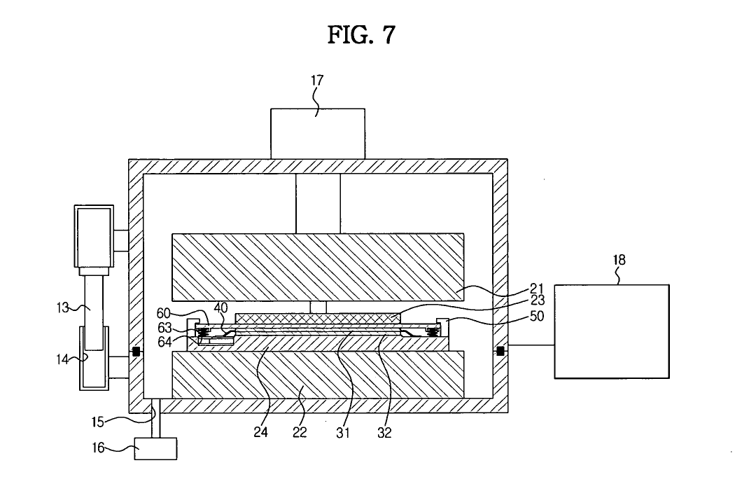

FIG. 6 is a view showing the spacer being separated from between the wafers according to the example embodiment of the present invention, and FIG. 7 is a view showing a pressing member pressing the push member according to the example embodiment of the present invention.

As shown in FIGS. 1 to 7, the wafer bonding apparatus according to the example embodiment of the present invention may create a vacuum in the vacuum chamber 10 by operating the vacuum pump 16 when the support member 24 is in the vacuum chamber 10. Because the spacer 40 may be inserted between the upper wafer 31 and the lower wafer 32, a vacuum may be created in a gap between the upper wafer 31 and the lower wafer 32. Therefore, an air trap may be prevented from occurring between the upper wafer 31 and the lower wafer 32 when the upper wafer 31 and the lower wafer 32 are bonded to each other. The air trap represents a phenomenon in which air is trapped between the upper wafer 31 and the lower wafer 32 when the upper wafer 31 and the lower wafer 32 are bonded to each other.

The spacer 40 may include an insertion part 41, a second body part 42, which may be connected to the insertion part 41 and may reciprocate on the support member 24, and a driving apparatus for moving the spacer 40. As shown in FIG. 6, as the driving apparatus operates, the spacer 40 may be separated from between the upper wafer 31 and the lower wafer 32 so that the upper wafer 31 and the lower wafer 32 adhere to each other. As described above, because the load of the push member 60 is partially supported by the first elastic member 64, the load is not excessively applied to the spacer 40. Accordingly, the upper wafer 31 or the lower wafer 32 may be prevented from being excessively deformed by the load of the push member 60 while the spacer 40 is being separated.

As the vertical moving apparatus 17 operates, the upper stage 21 may move downward and the pressing member 23 may press the push member 60. For example, the pressing member 23 may press the transfer part 61 of the push member 60. The upper wafer 31 may be bonded to the lower wafer 32 under appropriate heat and pressure. In particular, while the pressing member 23 is pressing the push member 60, the push member 60 may be fixed to the support member 24 by the fixing apparatus 50, so that the upper wafer 31 and the lower wafer 32 may be prevented from being misaligned when the pressing member 23 makes contact with the push member 60. In addition, because the fixing apparatus 50 supports the fixing part 62 of the push member 60, interference between the pressing member 23 and the fixing apparatus 50 may be prevented or reduced. Accordingly, the fixing apparatus 50 may not need to be released when the pressing member 23 presses the push member 60. As a result, the misalignment between the upper wafer 31 and the lower wafer 32 may be prevented or reduced when the fixing apparatus 50 is released.

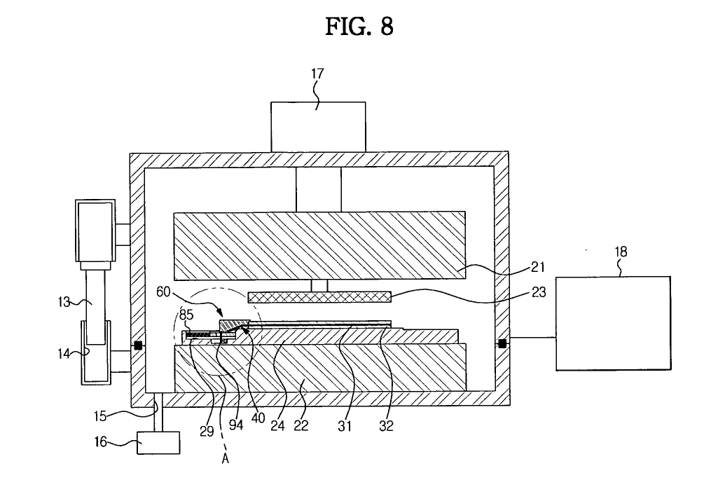

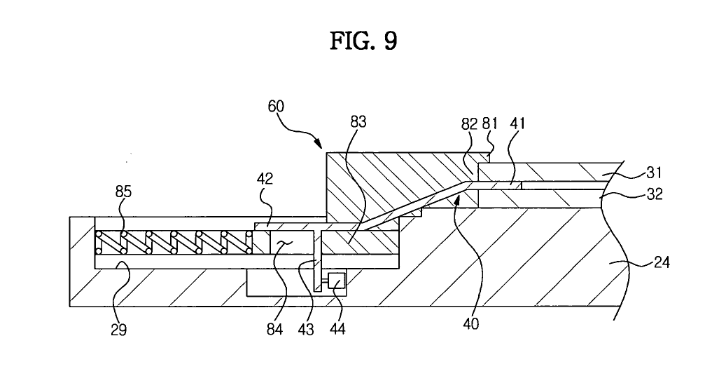

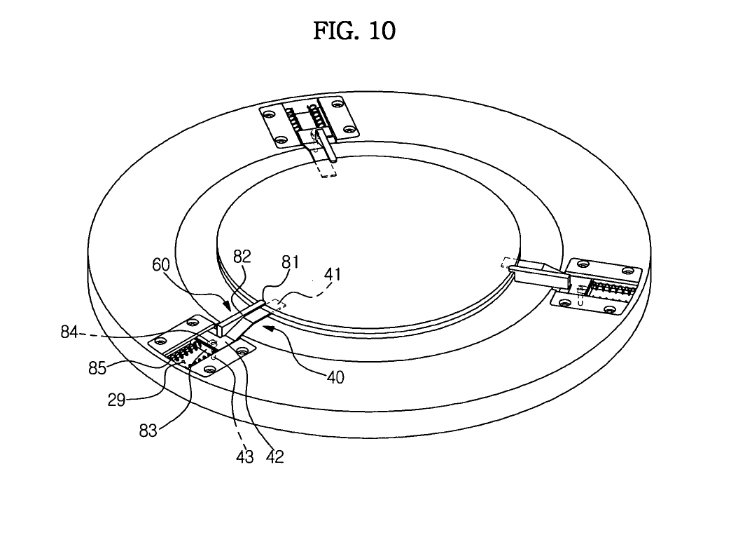

FIG. 8 is a view representing a wafer bonding apparatus according to a second example embodiment of the present invention, FIG. 9 is an enlarged view of ‘A’ shown in FIG. 8, and FIG. 10 is a view representing a support member according to the second embodiment of the present invention.

As shown in FIGS. 8 to 10, in a wafer bonding apparatus according to the second example embodiment of the present invention, a push member 60 may press a periphery of an upper wafer 31 and a lower wafer 32. In this regard, a plurality of push members 60 may be provided along the periphery of the upper wafer 31 and the lower wafer 32 while being spaced apart from each other at a regular interval. The push members 60 may be elastically supported by a support member 24 such that the upper wafer 31 and the lower wafer 32 are pressed toward the center thereof. The push member 60 may align the upper wafer 31 with the lower wafer 32 and maintain the alignment state of the upper wafer 31 and the lower wafer 32. In addition, the push member 60 may be provided with a projection 81 for covering a portion of the upper wafer 31, thereby preventing the upper wafer 31 from being separated from the support member 24 by external impact when the support member 24 is transferred or manipulated.

The push member 60 may include a pressing part 82 and a first body part 83 which may be connected to the pressing part 82 and may reciprocate on the support member 24. The pressing part 82 may press the upper wafer 31 and the lower wafer 32 toward the center thereof such that the upper wafer 31 and the lower wafer 32 are aligned with each other while maintaining the alignment state of the upper wafer 31 and the lower wafer 32. The first body part 83 may perform reciprocating motion while being inserted into a mounting groove 29 of the support member 24. As the first body part 83 moves, the pressing part 82 may apply a force to the upper and lower wafers 31 and 32 or may release the force when being separated from the upper and lower wafers 31 and 32. In addition, because the first body part 83 may be elastically supported by a second elastic member 85, the pressing part 82 may always be biased toward the upper wafer 31 and the lower wafer 32. The second elastic member 85 may have a first end supported by the first body part 83 and a second end supported by the support member 24.

A spacer 40 may include an insertion part 41 that may be inserted between the upper wafer 31 and the lower wafer 32 and a second body part 42, which may be connected to the insertion part 41. The second body part 42 may be installed on the support member 24 to perform reciprocating motion. The second body part 42 may be slid on the first body part 83 and may be connected to a driving apparatus 44 to perform the reciprocating motion.

The push member 60 may reciprocate while interacting with the spacer 40. The second body part 42 may overlap with the first body part 83 such that the second body part 42 may slide on the first body part 83. An interlocking projection 43 may be formed on the first body part 83 and may be inserted into an interlocking groove 84 formed on the second body part 42. The interlocking groove 84 may be provided in the form of an elongation groove that may allow the interlocking projection 43 to move therein by a predetermined or preset distance. Accordingly, when the second body part 42 is slid on the first body part 83, the interlocking projection 43 may move in the interlocking groove 84. When the second body part 42 makes contact with a side of the interlocking groove 84, the first body part 83 and the second body part 42 may be simultaneously transferred.

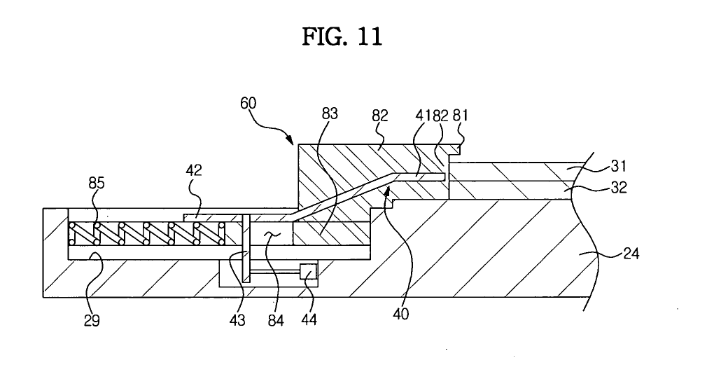

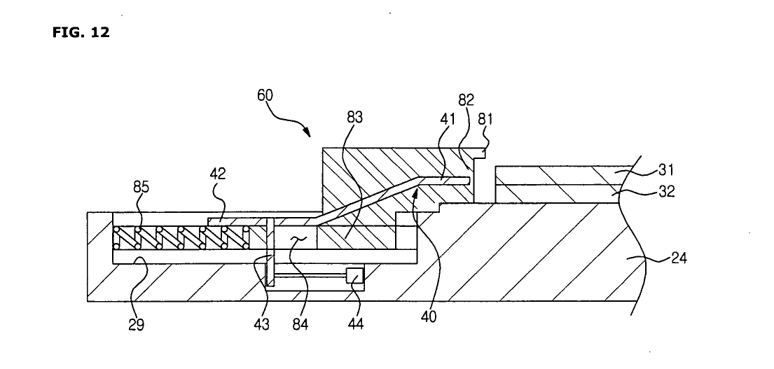

FIG. 11 is a view showing a spacer separated from between wafers according to the second example embodiment of the present invention, and FIG. 12 is a view showing the spacer 40 interacting with a push member 60 according to the second example embodiment of the present invention.

As shown in FIGS. 8 and 12, the wafer bonding apparatus according to the second example embodiment of the present invention may create a vacuum in a vacuum chamber 10 by operating a vacuum pump 16 when the support member 24 is in the vacuum chamber 10. The vacuum may prevent an air trap from forming between the upper wafer 31 and the lower wafer 32 when the upper wafer 31 is bonded to the lower wafer 32 for reasons similar to those set forth above.

As shown in FIG. 11, the spacer 40 may be separated from between the upper wafer 31 and the lower wafer 32 according to an operation of the driving apparatus 44. As a result, the upper wafer 31 may adhere to the lower wafer 32. Because the push member 60 may press the upper wafer 31 and the lower wafer 32, the upper wafer 31 may be aligned with the lower wafer 32. While the spacer 40 is separated from between the upper wafer 31 and the lower wafer 32, the interlocking projection 43 may move in the interlocking groove 84 having the elongation groove, so that the second body part 42 is slid on the first body part 83.

As shown in FIG. 12, if the spacer 40 is farther spaced apart from the upper wafer 31 and the lower wafer 32 according to the operation of the driving apparatus 44, the interlocking projection 43 may be locked with the interlocking groove 84, so that the second body part 42 and the first body part 83 move simultaneously. In this example, the push member 60 may not make contact with the upper wafer 31 and the lower wafer 32. Because the push member 60 may move while interacting with the spacer 40, an additional driving apparatus for moving the push member 60 may not be required, so that the manufacturing cost of the wafer bonding apparatus is reduced or minimized.

If the vertical moving apparatus operates, an upper stage 21 may move downward and the pressing member 23 may press the upper wafer 31. The upper wafer 31 and the lower wafer 32 may be bonded to each other under appropriate heat and pressure.

Although few example embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A wafer bonding apparatus comprising:
a support member configured to support an upper wafer and a lower wafer;
a push member on the upper wafer; and
a fixing apparatus configured to fix the push member to the support member, wherein the push member includes a fixing part extending outward from a periphery of the upper wafer, and the fixing apparatus is coupled to the fixing part.

2. The wafer bonding apparatus as claimed in claim 1, wherein the push member includes a transfer part configured to contact the upper wafer.

3. The wafer bonding apparatus as claimed in claim 2, further comprising:
a pressing member configured to press the upper wafer and the lower wafer against each other, wherein the pressing member presses the transfer part.

4. The wafer bonding apparatus as claimed in claim 1, wherein the push member is elastically supported by the support member.

5. The wafer bonding apparatus as claimed in claim 4, wherein the push member includes an elastic member.

6. The wafer bonding apparatus as claimed in claim 1, further comprising:
a plurality of alignment pins supported by the push member and the support member,
wherein the plurality of alignment pins are along the periphery of the upper wafer and a periphery of the lower wafer and are configured to restrict a movement of the upper wafer and the lower wafer.

7. The wafer bonding apparatus as claimed in claim 6, wherein the upper wafer and the lower wafer include notch parts at edges of the upper wafer and the lower wafer so as to accommodate a portion of an alignment pin of the plurality of alignment pins.

8. The wafer bonding apparatus as claimed in claim 6, wherein
the push member includes a first alignment pin groove,
the support member includes a second alignment pin groove, and
an alignment pin of the plurality of alignment pins is configured to extend through the first alignment pin groove and into the second alignment pin groove.

9. The wafer bonding apparatus as claimed in claim 8, wherein a plurality of alignment pin grooves are provided corresponding to the plurality of alignment pins, and at least one of the alignment pin grooves of the plurality of alignment pin grooves is provided in a form of an elongation groove.

10. The wafer bonding apparatus as claimed in claim 1, further comprising:
a spacer assembly configured to maintain a gap between the upper wafer and the lower wafer,
wherein the spacer assembly is configured to support one of the upper wafer and the lower wafer.

11. The wafer bonding apparatus as claimed in claim 10, wherein the spacer assembly includes a spacer having elasticity, and the spacer biases the upper wafer to the push member or biases the lower wafer to the support member.

12. The wafer bonding apparatus as claimed in claim 11, wherein the spacer includes a leaf spring.

13. The wafer bonding apparatus as claimed in claim 1, further comprising:
a vacuum chamber configured to receive the upper wafer and the lower wafer to provide a vacuum environment for bonding the upper wafer to the lower wafer; and
an aligner outside of the vacuum chamber to align the upper wafer with the lower wafer.

14. A wafer bonding apparatus comprising:
a support member configure to support an upper wafer and a lower wafer; and
a push member configured to apply a load to the upper wafer and the lower wafer, wherein the push member is on an outer side of an edge of the upper wafer and the lower wafer and is on the support member.

15. The wafer bonding apparatus as claimed in claim 14, further comprising:
a pressing member configured to press the upper wafer.

16. The wafer bonding apparatus as claimed in claim 14, wherein the push member is elastically supported by the support member and is configured to contact the upper wafer and the lower wafer.

17. A wafer bonding apparatus comprising:
a push member configured to elastically support an upper wafer and a lower wafer;
a spacer between the upper wafer and the lower wafer; and
a driving apparatus for moving the spacer, wherein spacer is configured to move the push member.

18. The wafer bonding apparatus as claimed in claim 17, wherein the push member includes a first body part having an interlocking groove, the spacer includes a second body part having an interlocking projection, and the interlocking projection is in the interlocking groove.

19. The wafer bonding apparatus as claimed in claim 18, wherein the interlocking groove is an elongation groove larger than the interlocking projection.

20. A method of bonding an upper wafer and a lower wafer, comprising:
aligning the lower wafer and the upper wafer on a support member;
placing the support member with the aligned lower and upper wafers into a vacuum chamber;
creating a vacuum in the vacuum chamber;
withdrawing at least one spacer from between the lower and the upper wafer so that the upper wafer and the lower wafer contact one another; and
operating a vertical moving apparatus to press the upper wafer against the lower wafer.

21. The method of claim 20, wherein aligning the lower wafer and the upper wafer includes
placing the lower wafer on a support part of the support member;
moving the at least one spacer over the lower wafer;
placing the upper wafer on the at least one spacer;
placing a fixing part of a push member on the upper wafer; and
moving a fixing apparatus to fix the push member to the support member.

22. The method of claim 20, wherein aligning the lower wafer and the upper wafer includes
placing the lower wafer on the support member;
moving the at least one spacer to support the lower wafer;
operating a moving apparatus to move a push member against the support member using at least one position detection camera; and
moving a fixing apparatus to fix the push member to the support member.

23. The method of claim 20, wherein withdrawing the at least one spacer includes operating a driving apparatus to move the at least one spacer out from between the upper wafer and the lower wafer.

24. The method of claim 23, wherein the at least one spacer includes an interlocking projection configured to contact the driving apparatus.
